(19) United States
(12) Patent Application Publication
(10) Pub. No.: US 2013/0117242 A1
(43) Pub. Date: May 9, 2013

(54) Adaptive Data Suppression

(71) Applicants: Marcel Kassner, Hockenheim (DE); Ole Krueger, Wiesloch (DE)

(72) Inventors: Marcel Kassner, Hockenheim (DE); Ole Krueger, Wiesloch (DE)

(73) Assignee: SAP, AG, Walldorf (DE)

(21) Appl. No.: 13/293,036

(22) Filed: Nov. 9, 2011

(51) Int. Cl. G06F 7/00

(52) U.S. Cl. 707/693; 707/687; 707/E17.002

(57) ABSTRACT

Systems, method and devices for adaptively suppressing data items based on one or more dynamic characteristics of the data items are disclosed. Adaptive data suppression of an operational data item may be accomplished by monitoring the operational data item for one or more dynamic characteristics required by a data aging rule associated with the operational data item, wherein at least one of the database and operational data item are stored in memory, detecting the one or more dynamic characteristics required by the data aging rule, recording the one or more detected dynamic characteristics and assessing whether the one or more detected dynamic characteristics satisfy the data aging rule. If a data aging rule is satisfied, the operational data item may be suppressed to persistent data storage. Related systems, methods, and articles of manufacture are also described.

### TECHNICAL FIELD

The present disclosure generally relates to data suppression.

### BACKGROUND

Generating and storing large volumes of data has reached critical mass. Comprehensive application software, the Internet and new computing and storage technologies have made it easier to create and collect all types of data. Where companies once managed megabytes and gigabytes of data, they now handle terabytes and petabytes. As companies accumulate increasing volumes of data, managing, accessing and storing this information cost-effectively is becoming a critical business challenge.

Many companies continue to store rarely-used data in high-cost, fast-performance databases. The business value of data generally decreases over time in proportion to its usage. However, when rarely-used data is needed, its value immediately increases and instant access is required. In turn, companies invest millions of dollars in complex, high-volume databases and compatible business-critical applications. Yet, notwithstanding these investments, high-volume databases still become overloaded and degrade system performance. Accordingly, there comes a point of diminishing returns where the cost to provide optimal access to rarely-used data outweighs the actual business value derived from that data. At this point, it makes sense to move such data from a high-cost, fast-response system to slower, low-cost long-term data store that better matches its business value.

Moving data into data storage for long-term retention is commonly termed data archiving or data suppression. Conventional suppression methods identify when a specific data item should be moved to long-term storage using static protocols that set specific dates at which suppression is to occur (e.g., when a data item is five years old). These methods typically place the burden of designing and instituting data suppression protocols upon system users (e.g., application developers, end-users, etc.) and, as a result, suffer several disadvantages. Requiring users to intelligently predict the optimal length of time for a data item to be kept in an operational database and, in turn, when that data item should be suppressed to long-term data storage, not only leads to increased complexity at the consumer level, but also provides for a high probability of insufficiently allocated memory and decreased system performance. That is, because users have no way of accurately determining ahead of time how often specific data is going to be accessed, users may institute protocols that prematurely suppress data that is still frequently used and/or keep data in an operational database that is rarely, if ever, used.

### SUMMARY

In some of the implementations described herein, a computer program product may be tangibly embodied in a non-transitory machine-readable medium and contain instructions to cause a data processing apparatus to perform operations that include monitoring an operational data item of a database for one or more dynamic characteristics required by a data aging rule associated with the operational data item, wherein at least one of the database and operational data item are stored in memory, and detecting one or more dynamic characteristics required by the data aging rule. Some implementations may include recording the one or more detected dynamic characteristics, assessing whether the one or more detected dynamic characteristics satisfy the data aging rule and suppressing the operational data item to a long-term data store when the data aging rule is satisfied.

Articles are also described herein that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more operations described herein.

It should be noted that, while the descriptions of specific implementations of the current subject matter may discuss delivery of enterprise resource planning software to one or more organizations, in some implementations via a multi-tenant system, the current subject matter is applicable to other types of software and data services access as well. The scope of the subject matter claimed below therefore should not be limited except by the actual language of the claims.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows an example system for suppressing data according to some implementations of the present disclosure.

FIG. 2 illustrates a database containing a plurality of operational data items having bit vectors according to some implementations of the present disclosure.

FIGS. 3a-3c illustrate an operational data item having a bit vector with bits representing each quarter of a year according to some implementations of the present disclosure.

FIG. 4 illustrates an operational data item having a bit vector with one bit for each month of the year according to some implementations of the present disclosure.

FIG. 5 illustrates an example of an operational data item having a seven-month bit vector according to some implementations of the present disclosure.

FIG. 6 illustrates an example of an operational data item having a nine-month bit vector according to some implementations of the present disclosure.

FIG. 7 illustrates a database having operational and aged partitions according to some implementations of the present disclosure.

FIG. 8 shows a flow diagram depicting an example methodology for adaptively suppressing data.

Like reference symbols in the various drawings indicate like elements.

### DETAILED DESCRIPTION

The subject matter disclosed herein relates to suppressing data items (e.g., tables, business objects, datasets, data cubes, etc.) from a location within an operational system (e.g., a high-cost, fast-performance database) to long-term data storage (e.g., a low-cost, slow-performance database) based on one or more dynamic characteristics of a data item, such as how frequently the data item has been accessed (e.g., read or modified) over a period of time, and/or one or more dynamic characteristics of an operational system within which the data item resides, such as how much available memory the operational system contains. Some embodiments of the present disclosure may employ one or more predefined data suppression algorithms (hereinafter “data aging rules”) configured to monitor a data item and/or an operational system and recommend or initiate suppressing the data item when one or more dynamic characteristics of the data item or corresponding system satisfy a data aging rule. In some implementations, the systems, methods and products of the present disclosure may reduce instances of misallocated memory resources, improve system performance and lower memory consumption and, as a result, overcome the disadvantages of conventional data suppression techniques that employ rigid, time-based archiving protocols which do not consider, for example, real usage characteristics of a data item or the amount of available memory of an operational system.

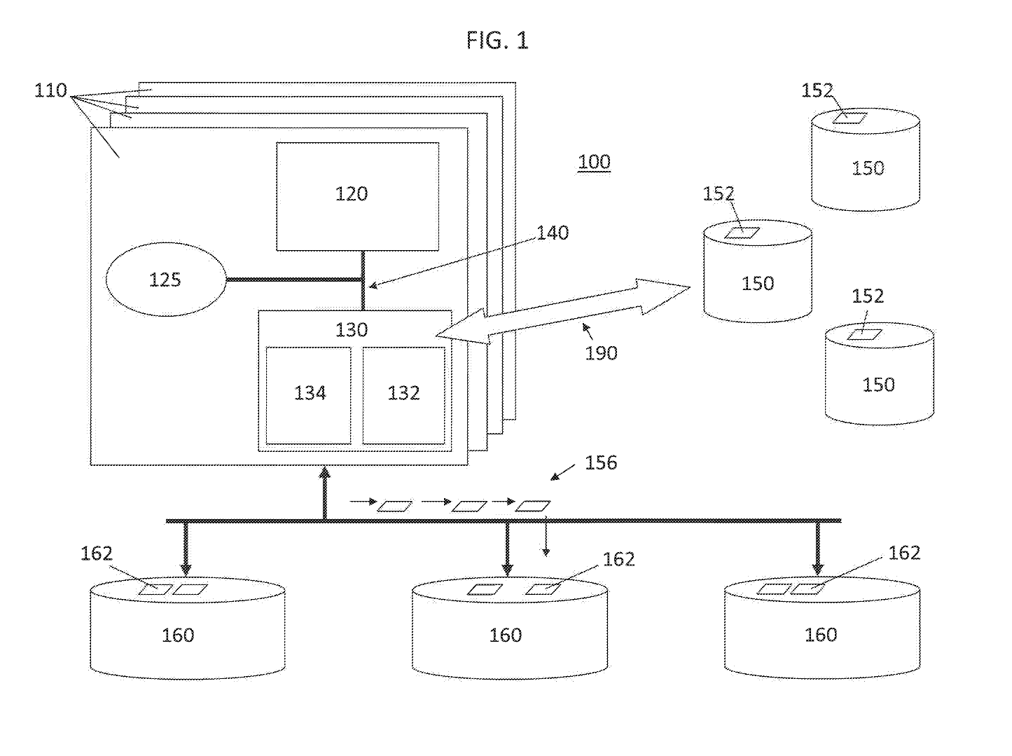

FIG. 1 shows a basic configuration of a system 100 for adaptively suppressing data based on one or more dynamic characteristics. System 100 may include a single computer 110 or a plurality of computers 110 in communication over a local area network, intranet and/or the Internet. A computer 110 may have a central processing unit (CPU) 120, a clock 125, a memory 130 and a communication mechanism, such as a bus 140, as shown in FIG. 1. Memory 130 may include volatile main memory 132 (e.g., random access memory or RAM) and non-volatile memory 134 (e.g., read-only memory or ROM).

The system 100 may also include one or more operational databases 150 that may, for example, store detailed enterprise data relating to the operations of a company (e.g., an online transaction processing, or OLTP, database) and/or data extracted for analytical processing (e.g., an online analytical processing, or OLAP, database). The term “operational” is used herein in conjunction with database 150 to denote an active database containing operational data items, in contrast to long-term data storage, discussed in more detail below. In some embodiments, the operational database 150 may be a relational database and employ database management system (DBMS) software to control the creation, movement, access, integrity and security of data items contained in the database 150. The DBMS may provide a layer of independence between data items contained in operational database 150 and any applications that use the data items. The DBMS data language may be any suitable language depending on the specific embodiment, including without limitation, Structured Query Language (SQL) for relational databases, Data Language Interface (DL/1) for IBM's Information Management System (IMS) or XQuery for XML databases. In some embodiments, the DBMS may control the data suppression functionalities of an operational database 150, including monitoring data items, recording and time-stamping dynamic characteristics of a data item and/or operational system and assessing whether the recorded dynamic characteristics of a data item satisfy one or more data aging rules.

Operational database 150 may be located in memory 130 of computer 110, as indicated in FIG. 1 by arrow 190. Operational database 150 may be located within main memory 132 (e.g., in the RAM) or within non-volatile memory 134 (e.g., on a hard disk), according to some embodiments. In some aspects of the present disclosure, operational database 150 may be configured to employ the resources of both the main memory 132 and the non-volatile memory 134. A computer 110 may contain one operational database 150 or, in some embodiments, a plurality of operational databases 150. One or more operational databases 150 may also be located remote from computer 110, such as on a central server in an enterprise resource planning (ERP) system or on a web server.

For example, the database 150 may be implemented as an in-memory database. Rather than use disk-based storage, an in-memory database keeps most, if not all, of the relevant database data items in main memory, such as RAM, dynamic RAM (DRAM), static RAM and the like. Database 150 may also be implemented as a column-oriented database, although a row-oriented database may be used as well. A column-oriented database refers to a DBMS configured to store relevant data based on columns, not rows. A row-oriented database refers to a database management system configured to store relevant data based on rows, not columns.

An operational database 150 may contain one or more operational data items 152, which may be, without limitation, tables, business objects, datasets or data cubes of any known data form, including text, images, sound and/or video. The term “operational” as used herein in conjunction with “data item” may refer to any data item expected to be needed for normal transactional and/or reporting operations of a business. Generally speaking, data items are often created by a transaction. For example, an operational data item 152 may be created when a sales order is entered into a company's ERP system or when a company receives payment of an invoice. Such transactions may take place at least partially within an operational database 150, wherein an operational data item 152 may be created. Otherwise, an operational data item 152 created outside an operational database 150 may be sent to and stored in the database 150 following its creation. During a transaction, the operational data item 152 may be referred to as “operational” in that it is needed to complete on-going business processing. At some point later, an operational data item 152 may no longer be needed to complete company transactions but may still be needed for reporting and/or querying purposes to produce internal reports or external statements. After some additional period of time later, an operational data item 152 may no longer be needed for completing business transactions, or for reporting and/or querying purposes. Thus, at some point in time, an operational data item 152 may be removed from the operational database 150 to free-up space in memory 130.

Operational data item 152 may still be needed, however, for regulatory compliance or other legal purposes. The system 100 thus includes one or more long-term data stores 160 for retaining and providing access to one or more aged data items 162, as shown in FIG. 1. The long-term data stores 160 may be located in computer 110 or situated remotely, such as on a network server. The term “aged” is used herein in conjunction with “data item” to refer to any data item that is no longer expected to be needed for normal transactional and/or reporting operations and, as a result, need not be kept in the memory 130 of a business' operational database 150. An aged data item 162 may be retained in a long-term data store 160 indefinitely, for some period of time and then later discarded or, in the some cases, discarded immediately.

Identifying that an operational data item 152 should be deemed an aged data item 162 and thus moved to a long-term data store 160 may be accomplished by assessing whether one or more dynamic characteristics of that data item (or a corresponding system) satisfy an associated data aging rule. To this end, the process of data suppression, according to some embodiments of the present disclosure, may begin with creating one or more data aging rules and associating them with one or more operational data items 152. The system 100 may be configured to allow an application developer and/or an end-user to create data aging rules through a user interface and using standard programming techniques. The data aging rules may be created and stored as algorithms within the DBMS of an operational database 150. The data aging rules may also be executed by the DBMS in conjunction with other component system 100 components, such as CPU 120 and clock 125. In some embodiments, the data aging rules may be fully or partially located within a separate data structure in a computer 110 or located remotely on a separate server in communication with one or more computers 110.

The data aging rules of the present disclosure may be configured as algorithms that instruct the DBMS of an operational database 150 to monitor operational data items 152 and record dynamic characteristics of operational data items 152 and assess whether such characteristics satisfy one or more data aging rules. In some embodiments, a data aging rule may include instructions that cause a DBMS to continuously monitor operational data items 152 of an operational database, detect, record and/or time-stamp dynamic characteristics of the data item 152 and periodically assess (e.g., once a week) whether such characteristics satisfy that data aging rule. For example, a user may have created a data aging rule that instructs the DBMS of an operational database 150 to monitor operational data items 152 relating to sales orders submitted for Company X in January 2008. This rule may instruct the DBMS to record every instance that such an operational data item 152 is accessed by a program or application and remove any data items 152 that are not accessed for six months in a row. Rather than record the status of dynamic characteristics, some embodiments of the present disclosure may read the recorded status and update that status only in situations where that status is not correct. Therefore, according to some embodiments, a respective bit (e.g., bit 230 described in more detail below) may always be read together with an operational data item 152 and only set if the bit (e.g., bit 230) has not already been set. In some implementations, it may be sufficient to record the dynamic characteristics of a data item 152 in memory and write it to a disk only occasionally (e.g., once a day), such that a loss of the recorded dynamic characteristic due to a system failure only costs a single day in data aging effectiveness. In some embodiments, a user may create a data aging rule that instructs a DBMS of an operational database 150 to record and time-stamp the creation of an operational data item 152 and then automatically “turn on” or activate that data aging rule.

After one or more data aging rules are created and associated with one or more operational data items 152, the data aging rules may be “turned-on” or activated manually by a user and/or automatically by the system 100. As a result, the DBMS of a corresponding operational database 150 may begin monitoring, detecting and recording dynamic characteristics of operational data items 152 in that database pursuant to an activated data aging rule. When the DBMS detects that a particular operational data item 152 has characteristics that satisfy a specific data aging rule, that data item 152 may be selected by the DBMS as appropriate for long-term data storage. Operational data item 152 may then be transferred to a long-term data store 160 as indicated at reference numeral 156 and thereafter referred to as an aged data item 162. Because a primary goal of data suppression is to maintain data items in a low-cost storage facility in case later use of a data item is required, aged data item 162 may be stored in a readily-accessible format so as to be retrievable on demand.

In some implementations, a user may configure a data aging rule to monitor, detect, record and assess dynamic characteristics of an operational data item 152 on a rolling basis until the data aging rule is satisfied. Alternatively, a user may configure a data aging rule to monitor, detect, record and assess dynamic characteristics of an operational data item 152 for a specified period of time. In such embodiments, dynamic characteristics recorded by the DBMS may be assessed against a corresponding data aging rule and a determination may be made (e.g., by the DBMS or by a user) as to whether a data item 152 should remain in operational database 150 (which is in memory) or be moved to a long-term, persistent data store 160.

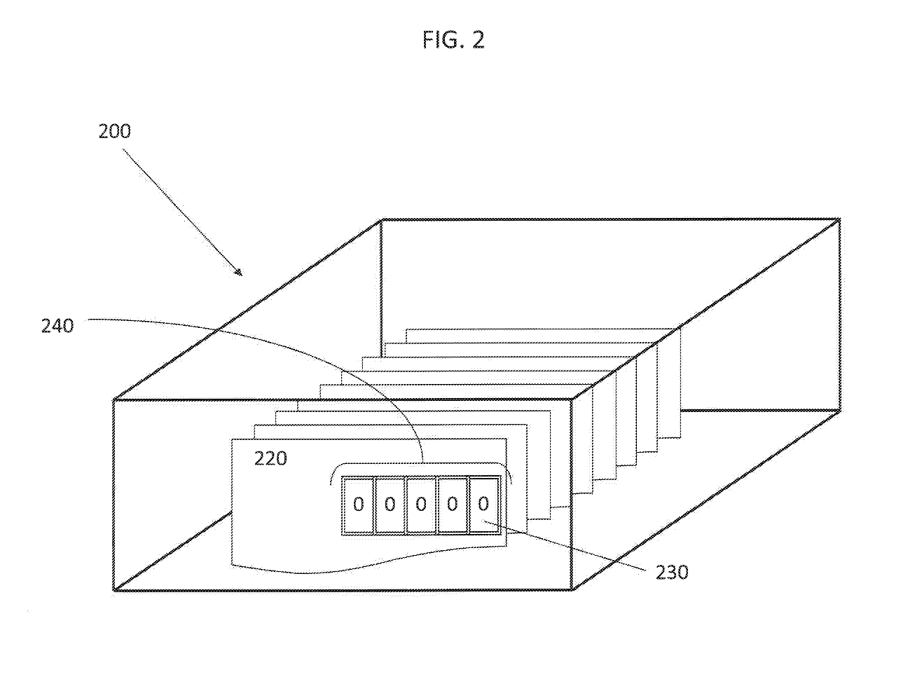

In some embodiments of the present disclosure, the dynamic characteristics of an operational data item that are monitored, detected, recorded and assessed pursuant to a data aging rule may relate to how frequently that operational data item is accessed (e.g., read or modified) by programs and/or applications. FIG. 2 illustrates a database 200 configured for monitoring, detecting and recording dynamic access frequency characteristics of one or more operational data items 220. These characteristics may be recorded by the DBMS using a bit vector or bit array of an operational data item 220. To this end, each operational data item 220 may have a bit vector 240 containing one or more bits 230, as shown in FIG. 2. The bit vector 240 may contain any number of bits 230 and each bit 230 may represent a designated time period, such as one week or one month.

Each bit 230 may be a binary digit denoted by the Arabic numerical digits “0” or “1” and may function as an indicator of whether a specific dynamic characteristic has been recorded for a designated time period. In general, a data aging rule may specify that a “0” bit be used by the DBMS to denote that no events occurred during a specified time period for a particular data item (e.g., a data item x was not accessed in January), in which case a dynamic characteristic detected and recorded for this time period could be that the data item was not accessed. Conversely, a data aging rule may specify that a “1” bit be used by the DBMS to denote that one or more events occurred during a specified time period for a particular data item (e.g., a data item x was accessed in January), in which case one or more dynamic characteristics could be detected and recorded for this time period to indicate one or more accesses of the data item. In some aspects, the binary digits “0” and “1” of the bit vector may represent logic values. For instance, “0” may equate to “False” or “No” and “1” may equate to “True” or “Yes.” While the bit vector 240 of the front operational data item 220 in FIG. 2 is shown as having five bits 230, the number of bits 230 in a given bit vector 240 of an operational data item 220 will vary depending on the criteria set forth in one or more corresponding data aging rules.

As shown in FIG. 2, every bit 230 of a bit vector 240 may at times be set to “0,” for example, when an operational data item 220 is first created. In some implementations, a data aging rule may instruct a DBMS to keep each bit 230 of a bit vector 240 as a “0” bit for a specified time period following the creation and initial access of the data item 220 during a transaction. In other embodiments, a data aging rule may instruct a DBMS to set a “0” bit to “1” when the data item 220 is created and then subsequently change the “1” bit back to “0” after a specified period of time. A bit vector 240 may also comprise all “0” bits when no event has occurred over a specified period of time and/or when the DBMS has cleared the bit vector 240 following the end of a time period specified by a data aging rule. In accordance with one or more data aging rules, the DBMS of the operational database 220 may set one or more of the “0” bits to “1” bits when a data aging rule is satisfied,

In some aspects of the present disclosure, the number of bits 230 in a bit vector 240 may be configured based on the increments of time specified by a data aging rule for assessing dynamic characteristics of a data item. That is, if a data aging rule requires data suppression of a data item after five straight months of no access, the bit vector of that data item must have at least five bits; otherwise, the DBMS would be required to write-over previous bits before an assessment as to whether the bit vector contains five “0” bits in a row could be made. The time period for data suppression may be dictated by the specific needs of applications and/or system requirements as defined by application developers and/or end-users.

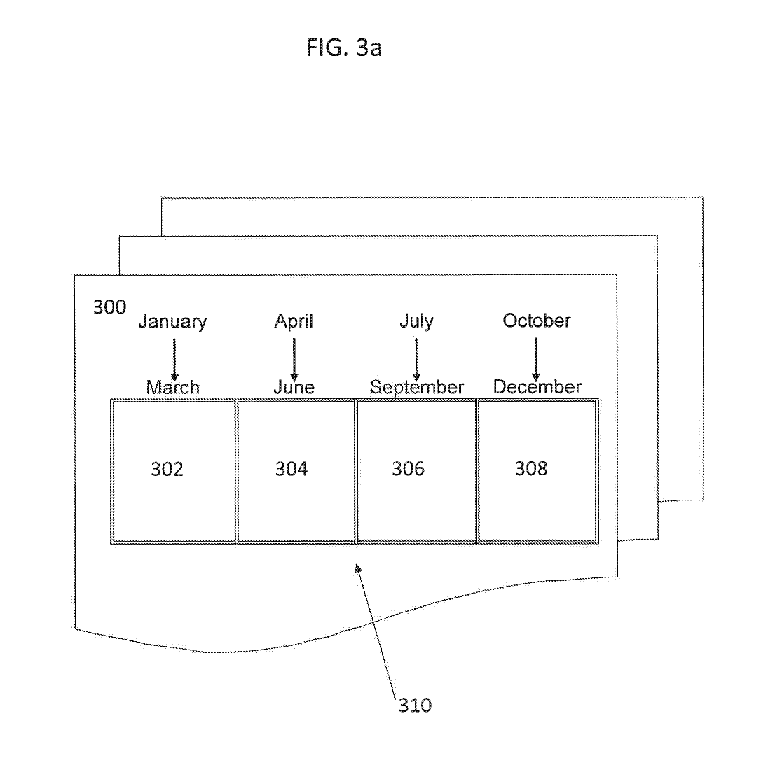

FIG. 3a shows an exemplary bit vector 310 that provides for the periodic assessment of one or more dynamic characteristics of a data item 300. In particular, bit vector 310 has been configured to assess dynamic characteristics of data item 300 on a quarterly basis and thus contains four bits—bits 302, 304, 306 and 308—for each quarter of a year. As shown in FIG. 3a, bit 302 equates to the January-March time period, bit 304 equates to the April-June time period, bit 306 equates to the July-September time period and bit 308 equates to the October-December time period.

Referring to FIGS. 3b and 3c, if operational data item 300 is accessed by a program or application during one of the quarters, the DBMS may detect and record the access as a dynamic characteristic of data item 300 by setting the “0” bit to a “1” bit. For example, if operational data item 300 is accessed one or more times in April, a data aging rule may instruct a DBMS to set bit 304 from “0” to “1,” as shown in FIG. 3b. If data item 300 is then not accessed again until January of the following year, bits 306 and 308 may remain “0” bits and bit 302 would be set to a “1” bit by DBMS, as shown in FIG. 3c. In some embodiments, a data aging rule may instruct a DBMS to clear the bit vector 310 after the time period for bit 308 has passed. Alternatively, as depicted in FIG. 3c, each bit may simply be written over at the end of the time period of that bit. For example, with reference to FIG. 3c, if data item 300 is not accessed during the April-June time period, bit 304 may be set from “1” back to “0”.

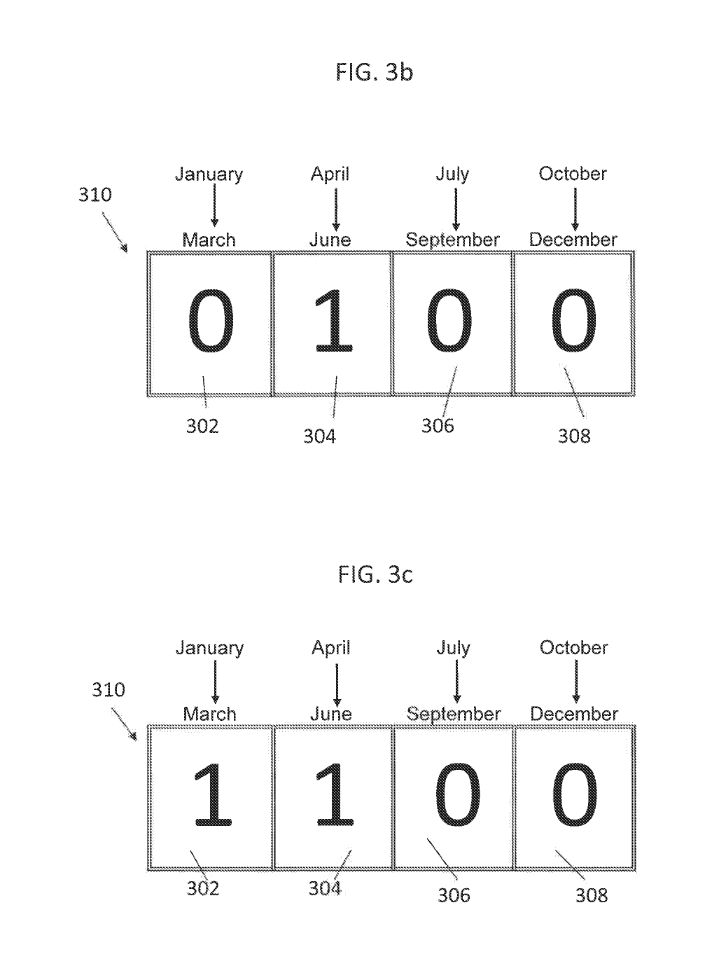

In some embodiments, a data aging rule may instruct the DBMS to continuously monitor, detect and record dynamic characteristics of a data item and assess on a rolling basis whether the dynamic characteristics satisfy the data aging rule until the data aging rule is satisfied. When the data aging rule is satisfied, the data item may be moved to long-term data storage. Accordingly, a data item could remain in an operational database for many years until a data aging rule is satisfied or, on the other hand, a data aging rule could be satisfied within just a few weeks or months, causing a data item to be moved to long-term data storage relatively quickly. More specifically, and with reference to FIG. 4, a data item 400 may contain a bit vector 410 having 12 bits, one for each month of the year. The data item 400 may be located in an operational database having a DBMS that contains a data aging rule that instructs the DBMS to remove data item 400 from its operational database to long-term data storage if data item 400 is not accessed (e.g., read or modified) for three consecutive months. Applying this data aging rule to bit vector 410 in FIG. 4, data item 400 would be removed from its operational database at the end of October, namely at bit 420, because for three consecutive months (August, September and October) data item 400 was not accessed. While FIG. 4 shows only 12 months of access history for data item 400, there could be many years of prior access history that have occurred before the bit vector 410 contained three consecutive “0” bits. In some embodiments, the bit vector 410 may clear itself and start over at the end of a 12-month cycle. In some embodiments, there does not necessarily have to be 12 bits to have a 12-month cycle. Rather, there could be a minimum of three bits, in accordance with the data aging rule requiring three consecutive “no access” months, and the DBMS may simply keep looping in a three-bit cycle.

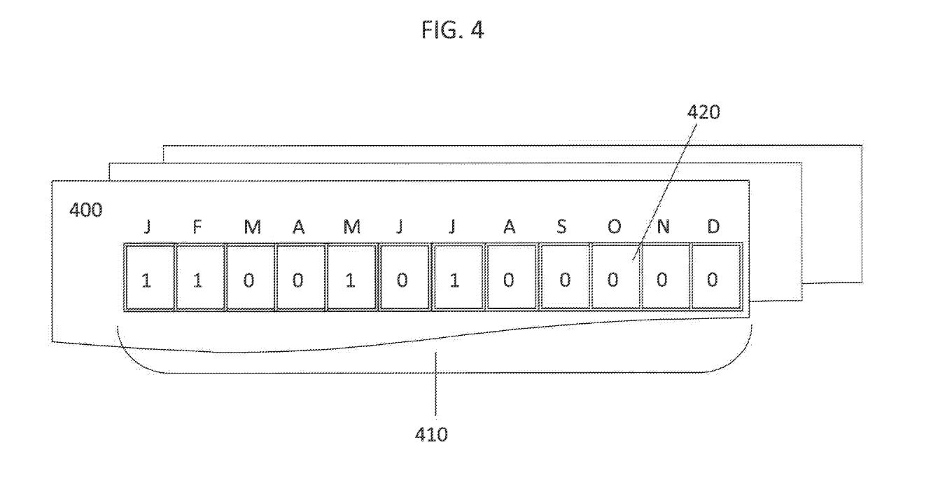

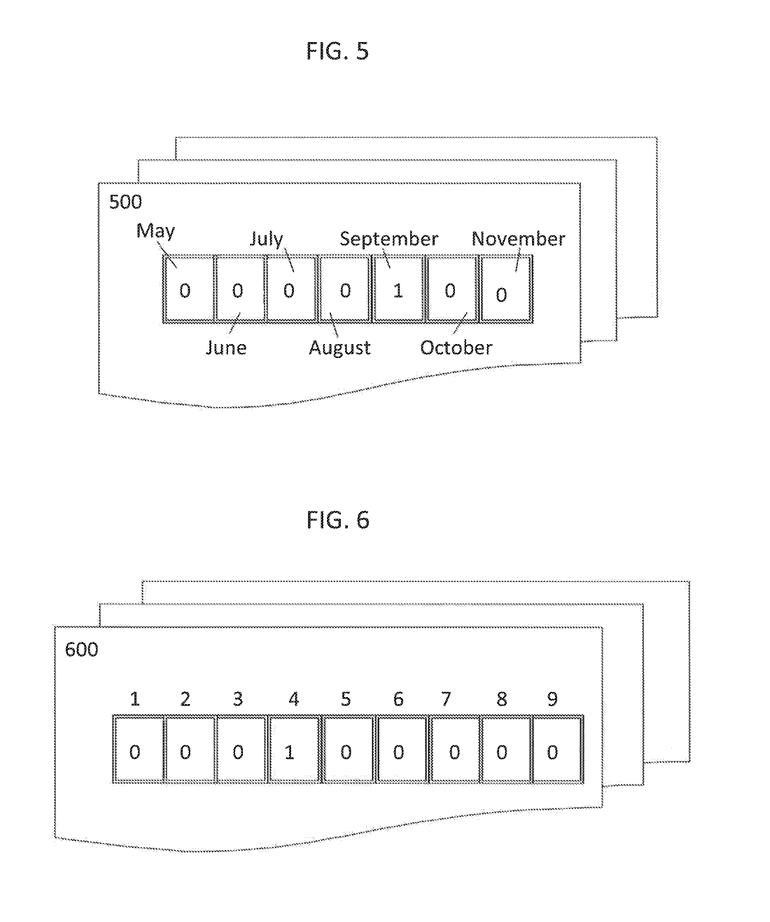

The data aging rule described with reference to FIG. 4 is merely exemplary. A user may create a data aging rule requiring data suppression after any desired time period. For example, a user may create a data aging rule that instructs a DBMS to suppress a data item 500 if that data item was accessed no more than one time over the past seven months, as shown in FIG. 5. In some embodiments, a data aging rule may be configured to move a data item to long-term data storage after a shorter time period, such as nine weeks. For instance, the DBMS may be required to deem an operational data item “aged” if it is not accessed more than one time over a nine-week period. As shown in FIG. 6, because data item 600 was only accessed during the fourth week of the nine-week time period, it may be moved to long-term storage. A user may also create a data aging rule that may perform random assessments of data items in an operational database and require suppression of any data item having an empty bit vector (i.e., all “0” bits) at the time the random assessment is performed.

In some embodiments, a data aging rule may instruct the DBMS to monitor, detect and record dynamic characteristics of a data item for a specified time period before assessing whether those characteristics may satisfy a data aging rule. For example, a data aging rule may instruct a DBMS of an operational database to monitor, detect and record dynamic characteristics of a data item for six months and, at the end of that time period, make a determination as to whether the data item should remain operational or should be deemed “aged” and moved to long-term data storage. In some embodiments, the recorded dynamic characteristics of a data item may be presented on a display screen via a user interface for assessment by a user. In other embodiments, a data aging rule may contain an algorithm that automatically suppresses the data item if the recorded dynamic characteristics satisfy a programmed condition, such as less than six accesses during the past year.

Some implementations of the present disclosure may involve data aging rules that suppress an operational data item based on one or more access frequency algorithms in combination with certain other programmed conditions. For example, a data aging rule may instruct a DBMS to suppress an operational data item if the operational data item has not been accessed for six consecutive months and the memory capacity of the main memory within which the operational data item is located is less than one gigabyte. In another example, a data aging rule may instruct a DBMS that, when the available memory in an operational database goes below a predefined minimum amount, any operational data items that have been in the database longer than two years and have not been accessed within the past eight months should be moved to long-term data storage. The data aging rule may provide further instructions to the DBMS that if the available memory in the operational database is still below the predefined minimum amount, the DBMS should move data items that have been in the database longer than 18 months and have not been accessed within the past six months.

In some embodiments, data items that all satisfy a particular data aging rule may be removed from the operational database to long-term data storage in an ordered manner, rather than all one time or randomly, based on one or more additional data aging rules. For example, for all data items that have been in the database longer than 18 months and have not been accessed within the past six months, as described above, a data aging rule may contain an additional algorithm that removes such data items in chronological order based on how long they have been stored in the operational database and/or based on the length of time since each data item was last accessed. That is, those data items stored the longest in the database and which have not been accessed for the longest time may be removed first. By removing data items in a one-by-one manner, the data aging rule may instruct the DBMS to stop removing data items as soon as the amount of available memory in the operational database goes back above the predefined minimum amount.

Embodiments of the present disclosure may also combine dynamic access frequency data aging rules with one or more of the static time-based archiving protocols disclosed in the prior art. For example, a data aging rule may instruct a DBMS to keep an operational data item in an operational database as long as the data item has been accessed at least one time every three months, but in no event longer than five years from its initial storage date. Thus, under this specific example, an operational data item may be suppressed to long-term data storage no later than five years after it was first stored in the database, even if it was accessed at least one time every three months.

In some embodiments, a data aging rule may be configured to actively influence data suppression in specific situations. More specifically, a data aging rule may be programmed to instruct a DBMS to overrule or otherwise manipulate a bit vector of a data item. That is, the DBMS may actively clear a bit vector in one or more data items when it is certain that such data item will not be used anymore. For example, when a data item is part of a business document that is a draft that has become obsolete or has since been rejected, the DBMS may be configured to recognize this, clear the bit vectors for all data items corresponding to this document and, thus, cause the document to either be moved to long-term data storage or discarded altogether,

In some embodiments, a data aging rule and/or the DBMS of an operational database may be configured to set the bits of a data item from “0” to “1” (or “1” to “0”) when the data item is being accessed by a program or application. Alternatively, some embodiments may provide a data aging rule and/or a DBMS of an operational database that is configured to set a bit of a data item from “0” to “1” (or “1” to “0”) asynchronously by executing the same query again in a subsequent and separate operation. Asynchronously setting one or more bits of data item may be optimized by aggregating single query conditions and executing one query per database dataset or table.

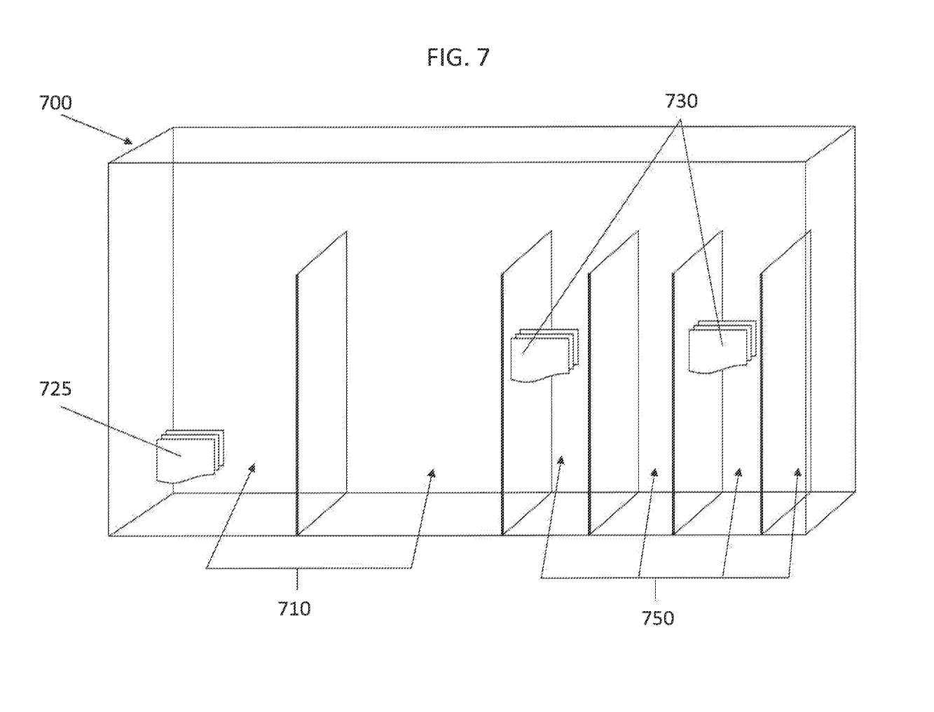

Some implementations of the present disclosure may involve data aging rules that instruct a DBMS to move an operational data item to a different location within an operational database, rather than into separate long-term data storage. More specifically, when a data item has one or more dynamic characteristics that satisfy a data aging rule, the data item may be moved into a separate partition within its operational database for additional monitoring during a probationary period and/or for eventual transmission to a separate long-term data store. FIG. 7 shows an operational database 700 divided into multiple logical partitions. One partition may be an operational partition 710 that contains operational data items 725. Data items that have been selected as aged data items 730 pursuant to one or more data aging rules may be transferred to an aged partition 750. Depending on the implementation, aged partitions 750 may exist, for example, for different weeks, months or years.

Aged data 730 located within an aged partition 750 may still be normally accessed by programs and applications and monitored by the DBMS. To this end, should aged data 730 experience an increase in access frequency, it may be loaded back into an operational data partition 710. Conversely, should aged data 730 continue to experience the same level of access frequency and/or a further decrease in access frequency, it may be moved to long-term data storage. The time period and/or conditions under which aged data 730 may remain in an aged partition 750 may be incorporated into the data aging rules executed by the DBMS. In some implementations, solid state disks may be used to store some or all of the aged partitions 750 to speed up loading of aged data 730 back into operational partitions 710.

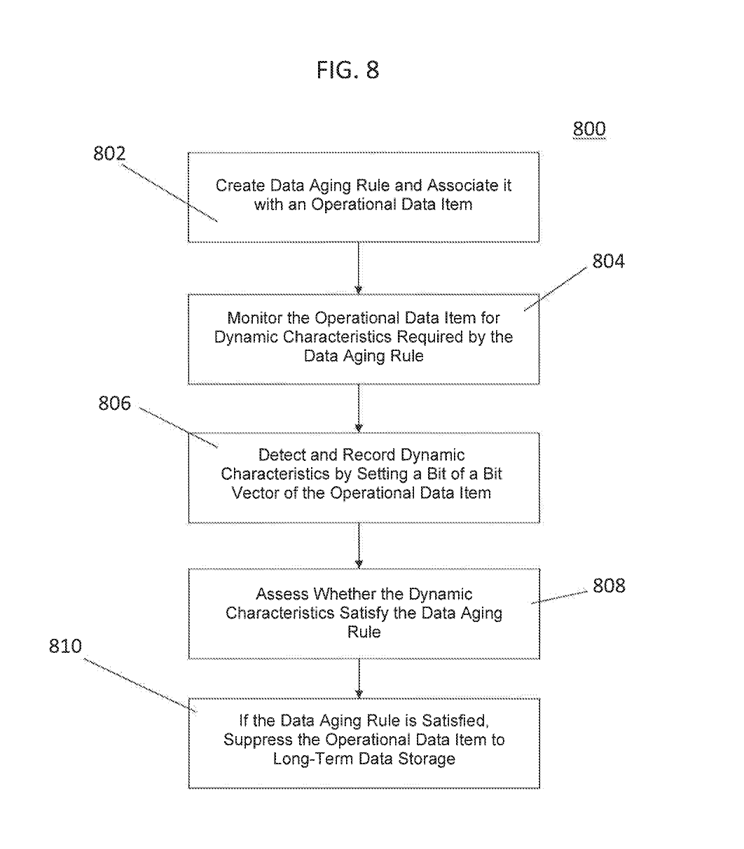

FIG. 8 shows a flow diagram depicting an example methodology 800 for adaptively suppressing data according to implementations of the present disclosure. At step 802, a data aging rule containing protocols for determining when operational data items should be suppressed may be created and stored within a database and/or other memory component of a computer or computer network. As part of step 802, a data aging rule may also be associated with one or more operational data items upon which the data aging rule may operate. At step 804, the data aging rule may instruct a DBMS of an operational database to monitor one or more operational data items of the operational database for dynamic characteristics required by the data aging rule. In some embodiments, dynamic characteristics required by the data aging rule may include reads, writes or other operations upon an operational data item. At step 806, the DBMS may detect and record any dynamic characteristics of the operational data item by setting a bit of a bit vector of the operational data item. For example, when an operational data item is accessed (e.g., read or modified), the DBMS may set a “0” bit to a “1” bit. At step 808, the DBMS may assess whether the recorded dynamic characteristics of the operational data item satisfies the data aging rule. For example, if the data aging rule requires data suppression of a data item if the data item has not been accessed in the past three months, the DBMS would review the recorded dynamic characteristics to determine whether the data item had been accessed in the past three months. At step 810, the DBMS may suppress the operational data item to long-term data storage if the data aging rule is satisfied.

The subject matter described herein may be embodied in systems, apparatus, methods, and/or articles depending on the desired configuration. Embodiments of the subject matter described herein may be realized in digital electronic circuitry, integrated circuitry, specially designed application specific integrated circuits (ASICs), computer hardware, firmware, software and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device and at least one output device.

These computer programs, which may also be referred to as programs, software, software applications, applications, components or code, may include without limitation machine instructions for a programmable processor. Some embodiments of these computer programs may be implemented in a high-level procedural and/or object-oriented programming language and/or in assembly/machine language. As used herein, the term “machine-readable medium” refers to any computer program product, apparatus and/or device, including but not limited to magnetic discs, optical disks, memory and Programmable Logic Devices (PLDs), used to provide machine instructions and/or data to a programmable processor, including without limitation a machine-readable medium that receives machine instructions as a machine-readable signal. The term “machine-readable signal” may refer to any signal used to provide machine instructions and/or data to a programmable processor. The machine-readable medium may store machine instructions non-transitorily, as would a non-transient solid state memory, magnetic hard drive or any equivalent storage medium. The machine-readable medium may alternatively or additionally store machine instructions in a transient manner, as would, for example, a processor cache or other random access memory associated with one or more physical processor cores.

Processors suitable for the execution of a computer program include, by way of example, both general and special purpose microprocessors and any one or more processors of any kind of digital computer. Generally, a processor will receive instructions and data from read-only memory (ROM), random access memory (RAM) or both. The essential elements of a computer are a processor for executing instructions and one or more memory devices for storing instructions and data. Generally, a computer will also include, or be operatively coupled to receive data from and/or transfer data to one or more mass storage devices for storing data, e.g., magnetic, magneto-optical disks or optical disks. Media suitable for embodying computer program instructions and data include all forms of volatile (e.g., RAM) or non-volatile memory, including by way of example only semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein may be implemented on a computer having a display device, such as for example a cathode ray tube (CRT) or a liquid crystal display (LCD) monitor for displaying information to the user. The computer may also have a keyboard and/or pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback or tactile feedback. Similarly, input from the user to the computer may be received in any form, including but not limited to visual, auditory or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user may interact with an implementation of the subject matter described herein, or any combination of such backend, middleware, or front-end components. The components of the system may be interconnected by any form or medium of digital data communication, such as for example a communication network. Examples of communication networks include, but are not limited to, a local area network (“LAN”), a wide area network (“WAN”) and/or the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The embodiments set forth in the foregoing description do not represent all embodiments consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the embodiments described above may be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other embodiments may be within the scope of the appended claims.

What is claimed is:

1. A computer program product, tangibly embodied in a non-transitory machine-readable medium, the computer program product containing instructions to configure a data processing apparatus to perform operations comprising:
monitoring an operational data item of a database for one or more dynamic characteristics required by a data aging rule associated with the operational data item, wherein at least one of the database and operational data item are stored in memory;
detecting the one or more dynamic characteristics required by the data aging rule;
recording the one or more detected dynamic characteristics; and
assessing whether the one or more detected dynamic characteristics satisfy the data aging rule.

2. The computer program product of claim 1, wherein the data aging rule associated with the operational data item instructs a database management system of the database to suppress the operational data item to persistent data storage when one or more dynamic characteristics are detected.

3. The computer program product of claim 1, wherein the data aging rule instructs a database management system of the database to suppress the operational data item based on how many times the operational data item is accessed by an application during a specified time period.

4. The computer program product of claim 1, wherein at least one of the one or more dynamic characteristics relates to the operational data item being accessed by an application.

5. The computer program product of claim 1, wherein the recording further comprises setting a bit of a bit vector of the operational data item when the operational data item is accessed by an application.

6. The computer program product of claim 5, wherein the bit is set at the same time the operational data item is accessed by the application.

7. The computer program product of claim 1, wherein the monitoring, detecting, recording and assessing are continuously performed until the data aging rule is satisfied.

8. The computer program product of claim 3, wherein the data aging rule further comprises instructing the database management system of the database to suppress the operational data item based on the amount of memory available in the database.

9. A computer-implemented method comprising:
monitoring an operational data item of a database for one or more dynamic characteristics required by a data aging rule associated with the operational data item, wherein at least one of the database and operational data item are stored in memory;
detecting the one or more dynamic characteristics required by the data aging rule;
recording the one or more detected dynamic characteristics; and
assessing whether the one or more detected dynamic characteristics satisfy the data aging rule.

10. The computer-implemented method of claim 9, wherein the data aging rule associated with the operational data item instructs a database management system of the database to suppress the operational data item to persistent data storage when one or more dynamic characteristics are detected.

11. The computer-implemented method of claim 9, wherein the data aging rule instructs a database management system of the database to suppress the operational data item based on how many times the operational data item is accessed by an application during a specified time period.

12. The computer-implemented method of claim 9, wherein the recording further comprises setting a bit of a bit vector of the operational data item when the operational data item is accessed by an application.

13. The computer-implemented method of claim 9, wherein the monitoring, detecting, recording and assessing are continuously performed until the data aging rule is satisfied.

14. The computer-implemented method of claim 11, wherein the data aging rule further comprises instructing the database management system of the database to suppress the operational data item based on the amount of memory available in the database.

15. The computer-implemented method of claim 9, wherein at least one of the one or more dynamic characteristics relates to the operational data item being accessed by an application, wherein the monitoring, the detecting, the recording, and the assessing are implemented in at least one processor.

16. A system comprising:
a processor; and
a memory, the processor and memory configured to perform a method comprising:
monitoring an operational data item of a database for one or more dynamic characteristics required by a data aging rule associated with the operational data item, wherein at least one of the database and operational data item are stored in memory;
detecting the one or more dynamic characteristics required by the data aging rule;
recording the one or more detected dynamic characteristics;
assessing whether the one or more detected dynamic characteristics satisfy the data aging rule; and
suppressing the operational data item to a persistent data store when the data aging rule is satisfied.

17. The system of claim 16, wherein the data aging rule instructs a database management system of the database to suppress the operational data item based on how many times the operational data item is accessed by an application during a specified time period.

18. The system of claim 16, wherein the recording further comprises setting a bit of a bit vector of the operational data item when the operational data item is accessed by an application.

19. The system of claim 16, wherein the monitoring, detecting, recording and assessing are continuously performed until the data aging rule is satisfied.

20. The system of claim 17, wherein the data aging rule further comprises instructing the database management system of the database to suppress the operational data item based on the amount of memory available in the database.
